(19) United States
(12) Patent Application Publication
(10) Pub. No.: US 2016/0119785 A1
(43) Pub. Date: Apr. 28, 2016

(54) SYSTEM AND METHOD FOR MANAGING POSTS

(71) Applicant: Hyunil CHOI, Seattle, WA (US)

(72) Inventor: Hyunil CHOI, Seattle, WA (US)

(21) Appl. No.: 14/522,311

(22) Filed: Oct. 23, 2014

(51) Int. Cl. H04W 12/06; H04L 12/58; H04L 29/06; H04W 12/04

(52) U.S. Cl. CPC H04W 12/06; H04W 12/04; H04L 51/12; H04L 51/38; H04L 63/083

(57) ABSTRACT

Disclosed herein are a method and system for managing posts. The method for managing posts includes inputting post data from the user system A in a state in which a user Identification (ID) enabling the user system A to be discriminated from other user systems is not provided, assigning a temporary user ID enabling the user system A to be discriminated from other user systems, registering the post data input by the user system A, together with the temporary user ID, in a database (DB), and when a communication session between the user system A and the post service provider system is terminated, withdrawing the temporary user ID assigned to the user system A and deleting the post data and the temporary user ID registered in the DB.

### BACKGROUND OF THE INVENTION

1. Field of the Invention

The present invention relates generally to a system for managing posts and a method for operating posts using the system and, more particularly, to a system and method for managing posts, which assign a temporary user identification (ID) when a user enters data, and maintain the assigned temporary user ID.

2. Description of the Related Art

With the development of the Internet, a large number of websites, blogs, and social network services that enable users to exchange news or information with each other have been used. Such various Internet services prompt users to enter IDs so as to identify a large number of users.

Below, Facebook, known as having relatively high openness, will be described as an example. Facebook provides various free videos, and users may sufficiently enjoy the videos without entering their IDs. However, when desiring to post comments related to a specific video provided by a given website or to register a new video, users must subscribe to the corresponding website as members and log in to the website.

When a website is operated such that user IDs are entered, a lot of advantages may be obtained from the standpoint of the operator of the corresponding website. For example, it is convenient to manage videos or comments uploaded by a user to date, and it is possible to check a video area of interest. Further, when billing is required or it is desired to provide separate rewards, required information may be easily acquired as long as only user Ds are known, thus enabling websites to be smoothly operated.

However, there are some cases where, from the standpoint of a user, even when a login procedure is not required, the corresponding website requires such a procedure, thus inconveniencing the user. For example, a situation is assumed and described in which a user desires to sell a sofa that is not used any more in the user's house. The user visits and logs in to a used article transaction website, and then registers a picture and a description of the sofa. Of course, the user enters his or her contact information enabling the user to be contacted by a potential purchaser. In the case of a specific website, a separate agent number may also be presented for a user who does not desire to expose his or her direct contact information. Thereafter, if a potential sofa purchaser appears and transaction has been completed, the user again visits the corresponding website to revise the corresponding post by adding information indicating that the present article was sold, or to delete the corresponding post. Therefore, it can be seen that, in order for a user to achieve his or her purpose of selling the sofa via the used article transaction website, a login procedure is not necessarily required. In this way, only a space in the Internet in which information about the sofa to be sold and a seller's contact information can be provided is needed. However, there is a problem in that an inconvenient login procedure is required so as to perform such a simple task.

### PRIOR ART DOCUMENTS

### Patent Documents

(Patent Document 1) Korean Patent Application Publication No. 10-2009-0002189 (Date of publication: 2009.01.09)

### SUMMARY OF THE INVENTION

Accordingly, the present invention has been made keeping in mind the above problems occurring in the prior art, and an object of the present invention is to provide a system and method for managing posts, which assign a temporary user ID that can be temporarily used only when the entry of data is requested such as by a user registering a topic of interest, by posting comments on a topic registered by another person, or by doing chatting or making a phone call, in order to provide maximized convenience to the user and prevent personal information from being exposed, and which maintain the assigned temporary user ID and withdraw the temporary user ID if a session is terminated.

In order to accomplish the above object, the present invention provides a method for managing posts, the method being performed by a post service provider system connected between user system A and user system B via data communication and configured to provide a plurality of posts so that the posts are registered or viewed, and to provide data communication connection between the user system A and the user system B, including a) inputting post data from the user system A in a state in which a user Identification (ID) enabling the user system A to be discriminated from other user systems is not provided, b) assigning a temporary user ID enabling the user system A to be discriminated from other user systems, c) registering the post data input by the user system A at a), together with the temporary user ID assigned at b), in a database (DB), and c) when a communication session between the user system A and the post service provider system is terminated, withdrawing the temporary user ID assigned to the user system A and deleting the post data and the temporary user ID registered in the DB at c).

Additional aspects and/or advantages of the invention will be set forth in part in the description which follows and, in part, will be obvious from the description, or may be learned by practice of the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a system for managing posts according to an embodiment of the present invention;

FIG. 2 is a diagram illustrating a post management screen displayed on a user system using the post management system according to an embodiment of the present invention;

FIG. 3 is a diagram illustrating a communication screen displayed on each user system when a phone call is made between post operators presented in FIG. 2;

FIG. 4 is a flow diagram showing the flow of post management between user systems and a service provider system constituting the post management system according to an embodiment of the present invention;

FIG. 5 is a flow diagram showing a procedure, in which a user system A inputs post data and is assigned a temporary user ID from a service provider system, in the post management system according to the present invention;

FIG. 6 is a flow diagram showing a procedure, in which user system B selects a topic created by another user and is then assigned a temporary user ID from a service provider system, in the post management system according to the present invention;

FIG. 7 is a flow diagram showing a procedure, in which user system A and the service provider system are connected together to a third service and perform a service, in the post management system according to the present invention;

FIG. 8 is a flow diagram showing a procedure, in which user system A and the service provider system are connected to a third service to perform a service and the third service is performed on behalf of an operation executed by a conventional service provider system, in the post management system according to the present invention;

FIG. 9 is a diagram showing an embodiment of a program language, by which when user system A inputs post data, a temporary user ID is assigned to the user system from the service provider system, in the post management system according to the present invention;

FIG. 10 is a diagram showing an embodiment of a program language describing a procedure, in which an assigned temporary user ID is withdrawn when a user system assigned the temporary user ID terminates a web or an application in use and terminates a session, in the post management system according to the present invention;

FIG. 11 is a flow diagram showing a method in which the post management system stores post data according to the present invention;

FIG. 12 is a diagram showing examples of the configuration of a post database (DB) according to the present invention; and

FIG. 13 is a flow diagram showing a procedure, in which a phone call is made, in the post management system according to the present invention.

### DETAILED DESCRIPTION OF THE EMBODIMENTS

Hereinafter, embodiments of the present invention will be described in detail with reference to the attached drawings.

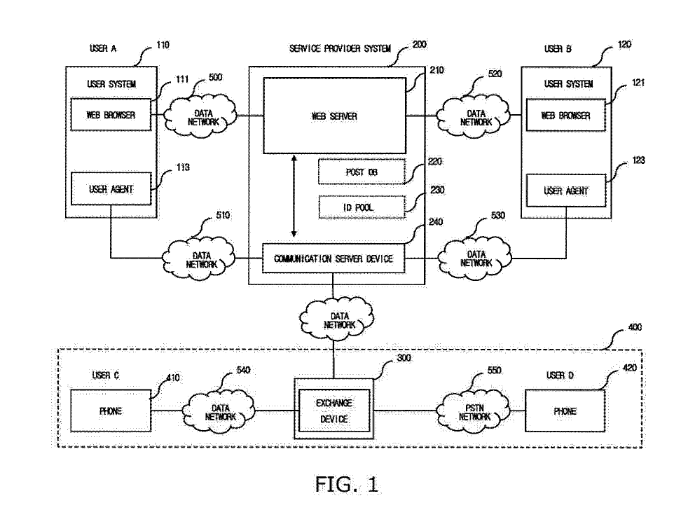

FIG. 1 is a configuration diagram showing a system for managing posts according to an embodiment of the present invention. The system for managing posts according to the present invention includes data networks 500, 510, 520, and 530 including the Internet and a wireless communication network, user system A 110 and user system B 120 connected to the data networks, and a service provider system 200 for providing a post management service between the user systems. Components shown in FIG. 1, that is, an exchange device 300, a data network 540 and a public switched telephone network (PSTN) 550, and the phone 410 of user system C and the phone 420 of user system D connected to the networks, denote an external communication system 400 separate from the post management system according to the present invention.

Each of the user system A 110 and the user system B 120 includes a web browser 111 or 121 and a user agent 113 or 123 connected to the service provider system 200 via communication and configured to register or view post data and perform chatting, text communication or voice communication with a user system that registered the corresponding post data. From HyperText Markup Language 5 (html5), the function of the user agent 113 or 123 for performing communication in association with data may be included in the web browser 111 or 121 provided in the user system A or B.

The service provider system 200 includes a web server 210 for providing a web service, a post database (DB) 220 into which pieces of data are arranged and stored, an ID pool 230 for assigning a plurality of temporary user IDs to be provided to the user system A 110 or the user system B 120, and a communication server device 240.

The external communication system 400 includes the exchange device 300 for performing an exchange function for telephone communication, the phone 410 of the user C connected to the data network, and the phone 420 of the user D connected to the PSTN. Technology for, when a user attempts to make a call in a state in which a phone ID for discrimination from other systems is not assigned, assigning a temporary phone identifier for discrimination from other phones to the user (strictly, a user system) who attempts to make a call connection and providing a call function is disclosed in detail in Korean Patent No. 10-1173840, U.S. Pat. No. 7,843,950, U.S. Pat. No. 8,842,683, and International Publication No. PCT/KR2009/002443 filed by the applicant of the present invention, and thus a detailed description thereof will be omitted.

Each of the user systems A 110 and B 120 is implemented using a personal computer (PC), a notebook computer or a mobile smart phone having a typical input/output device, or an electronic device connected to the Internet. The web browser 111 or 121 is a browser aimed at utilizing the Internet such as Internet Explorer, Chrome, or Firefox, and mainly provides data connection. However, with the development of technology, the web browser 111 or 121 may be directly used for accessing and utilizing communication based on industrial standards such as Web Real-Time Communication (Web RTC). The user system may include a plurality of application software programs and may perform a function of creating and editing post data such as document work, picture editing, magazine creation, and video editing. The user agent 113 or 123, which is a software module installed in the corresponding user system, provides a function of uploading or downloading post data while being connected to the service provider system 200 over a data network and of allowing the user to view data posted by another user. Further, when the user requests communication connection to another user, the user agent 113 or 123 is connected to the service provider system and then performs a series of procedures such as by initially setting up communication, performing communication with another party's device, and stopping communication. When a smart phone is used as the user system, the user agent 113 or 123 may be provided in the form of an application (App) program installed in the corresponding smart phone.

The service provider system 200 according to the present invention permits the user system 110 or 120 to search for post data provided by the service provider system 200 or perform web surfing in a state in which a user ID is not assigned. However, when the user system 110 or 120 takes a data action requiring a user ID, the service provider system 200 assigns a temporary user ID to be temporarily used while a session between the user system 110 or 120 and the service provider system 200 is connected in order to discriminate the corresponding user system 110 or 120 from other user systems. Such a service is referred to as a “Connection as a Service (CaaS)” in the present invention.

When the user system 110 or 120 takes a data action requiring a user ID, the following cases may occur: case (1) where the user accesses a website provided by the service provider system 200 and enters post data; case (2) where the user accesses a website provided by the service provider system 200 and selects post data; and case (3) where, when the user accesses a website provided by the service provider system or a service provider, the action is determined to be an action requiring an ID and a temporary user ID may be automatically provided, depending on the circumstances.

When such a data action requiring a user ID occurs, the service provider system 200 selects one from among temporary user IDs contained in the ID pool 230, assigns the selected ID to the user system 110 or 120, and allows the allocated ID to be used as a temporary user ID. Alternatively, the ID pool 230 is provided with a temporary user ID from a third external device and provides the temporary user ID to the user system 110 or 120. It is preferable that the temporary user ID be an identifier allowing the exchange device 300 to identify a specific phone so that the specific phone can be discriminated from other phones. Otherwise, since a temporary user ID for chatting (hereinafter referred to as a ‘chatting temporary user ID’) and a temporary user ID for a phone call (hereinafter referred to as a ‘call temporary user ID’) must be individually assigned to the same user, management inconvenience occurs.

The service provider system 200 includes the web server 210, the DB 220, the ID pool 230, and the communication server device 240. The service provider system 200 is a system that is connected to the web browser 111 or 121 or the user agent 113 or 123 of the user system 110 or 120 and that performs a data service for exchanging post data or a communication service for providing chatting or call connection, and simultaneously performs the data service and the communication service. The web server 210 is a server for providing a web service. After connecting, via communication, to the web browser 111 or 121 of the user system 110 or 120, or the user agent 113 or 123 that may include an application (App), or both the web browser and the user agent, the web server may receive post data from the user system or receive selection of one from among pieces of input post data. Thereafter, a temporary user ID is assigned to and designated for the corresponding post data from the ID pool 230 in a CaaS manner, and the corresponding post data together with the temporary user ID is stored in the DB 220. However, depending on the situation, the corresponding temporary user ID may be received from a third device other than the internal ID pool 230 and then the CaaS manner may be applied.

A simple usage example will be described below. The service provider system provides a temporary user ID to the user system or the user agent, in which the entry of post data is terminated, in a CaaS manner, and displays the post data entered by the user on a website or an App. Thereafter, when the user system (user agent) terminates a connection to the service provided by the service provider system (when a session is terminated), the service provider system withdraws the temporary user ID, previously allocated in the CaaS manner, and keeps the temporary user ID so that it may be used for another purpose. In this case, the post data received from the user and stored in the post DB 220 is also deleted. The post data stored in the post DB 220 is stored in such a way that it is association with the corresponding temporary user ID. Depending on the usage examples, it is possible to exceptionally store only post data entered or designated by users having no temporary user IDs or, in contrast, store only post data entered or designated by users having temporary user IDs. However, the post DB 220 may be implemented as an external DB such as in a cloud service, rather than the internal DB of the service provider system 200. Even in this case, the use of the external DB is implemented in the same manner as the use of the internal DB 220, and thus operation may be applied in the same manner as that of the internal DB.

The communication server device 240 is a server for relaying communication including chatting or call connection between the user system A 110 and the user system B 120. Further, the communication server device 240 functions to connect the user systems 110 and 120 to the external communication system 400 via the exchange device 300.

When telephone communication is set up, the exchange device 300 functions to connect to the external phone 410 or 420 or an external communication device to the service provider system 200. However, when terminals are directly connected during communication, the exchange device 300 may not be involved in the relay of communication. The exchange device 300 may be either the exchange of a communication company (private branch exchange (PBX) or an Internet Protocol-PBX (IP-PBX)) or may be the server of another service provider.

Each of the phones 410 and 420 denotes a telephone connected to the exchange device 300, and is a concept including not only a typical telephone making a call depending on a ringtone connected to the PBX, but also a soft phone operating based on software, such as a flash phone stored in a PC, a tablet computer or a smart device, or an Internet phone connected over the Internet.

Each of the data networks 500, 510, 520, 530, and 540 denotes a link path connected via data or communication between the user system 110 or 120 and the service provider system 200 using a communication method such as wired Local Area Network (LAN), wireless LAN, wireless Internet, Bluetooth communication, or direct communication between devices. The PSTN 550 denotes a path based on the existing communication network of a communication company.

It is apparent that a separate download server for downloading and installing the user agent 113 or 123 to and in the user system 110 or 120 may be further included in the service provider system 200. When the user agent 113 or 123 is implemented as an App used in a smart phone or a tablet PC, the server of an App service provider other than the service provider system 200 may be used, or the server of the third company such as a cloud server may be used. Further, in the present invention, the term “communication” denotes various types of communication such as voice communication or text communication such as chatting.

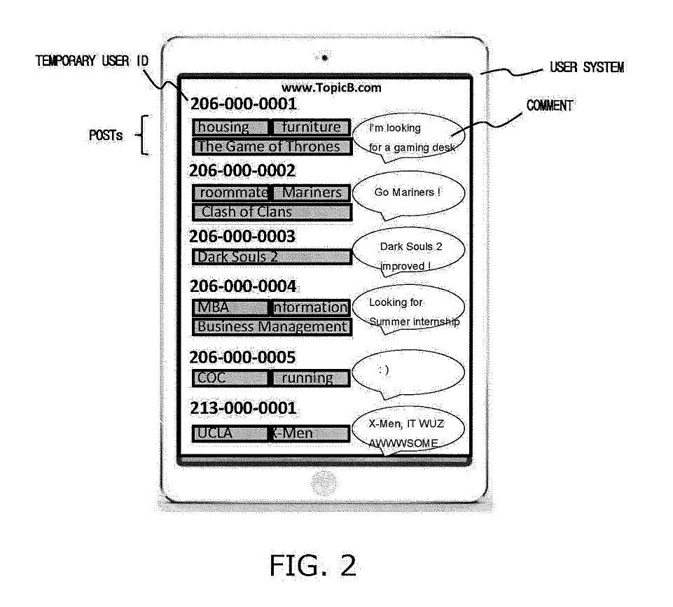

In the present invention, the term “post data” denotes all types of data that may be registered in the post management system, and more specifically denotes data implemented using at least one format selected from among pieces of multimedia data such as text, voice, a video, a picture, an image and an advertisement. Further, the term “topic” in the present invention denotes data enabling post data that is provided to the user system 110 or 120 via the web server to be simply characterized. For example, when post data is composed of text related to the selling of a used sofa and a picture of the sofa, text corresponding to a title indicative of the corresponding post data, such as “sofa on sale now” may be defined as the ‘topic’. As another example, when post data is composed of multimedia data such as a picture or a video, a thumbnail-sized image capable of characteristically representing the corresponding picture or multimedia data may be defined as a topic. The term “topic” will be described below using a substantial example with reference to FIG. 2.

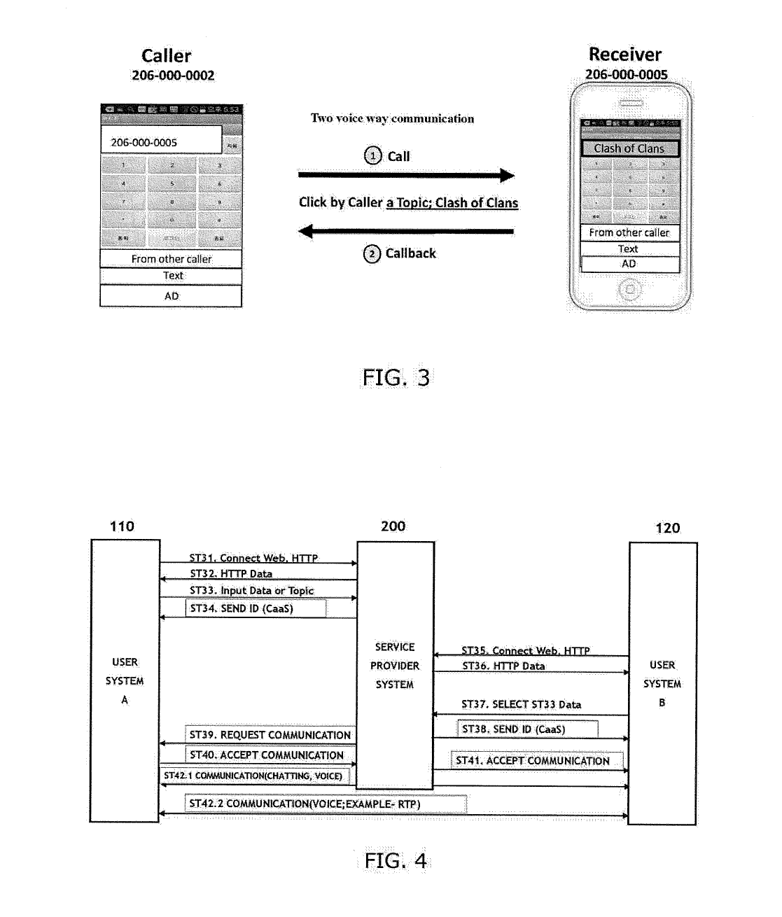

FIG. 2 is a diagram illustrating a post management screen displayed on a user system using the post management system according to an embodiment of the present invention, and FIG. 3 is a diagram illustrating a communication screen displayed on each user system when a phone call is made between post operators presented in FIG. 2. When a user visits a post management website (service provider system) according to the present invention and enters post data in a state in which a user ID is not assigned without entering any information including personal information, the service provider system assigns a temporary user ID to the corresponding user system. The temporary user ID assigned in this way is automatically deleted when the user system terminates a session with the service provider system. FIG. 2 illustrates a state in which a total of six users registered topics, and in which temporary user IDs 206-000-0001˜0005 and 213-000-0001 are assigned from the service provider system to respective users who registered post data. The temporary user IDs 206-000-0001˜0005 and 213-000-0001 denote identifiers assigned from the service provider system when the users enter the post data or click the entered post data, rather than being designated or entered by users. It can be seen that the user assigned the temporary user ID “206-000-0002” has registered three topics, that is, “roommate”, “Mariners”, and “Clash of Clans”, and has entered “Go Marines!” as a comment, and the user assigned the temporary user ID “206-000-0005” has registered two topics, that is, “COC” and “running”. From the topic “roommate”, it may be expected that the corresponding user takes an interest in a roommate. If the topic is clicked, post data composed of text or pictures related to the topic “roommate” is provided. The topic “Mariners” denotes post data related to a professional baseball team having a connection with San Francisco, and the topic “Clash of Clans” or an abbreviation “COC” denotes a topic indicating the title of a smart phone game popular at the time of filing of the invention. In this way, the term “topic” denotes data composed of a relatively small number of characters or small-size images, which are capable of characteristically representing the corresponding post data.

FIG. 3 is a diagram showing an example of a communication screen on which the user of the user system presented in FIG. 2 clicks a topic of interest “COC” registered by a user having a temporary user ID “206-000-0005” and makes a call to “206-000-0005” to perform communication. A left side of the drawing shows the screen of a caller having a temporary user ID “206-000-0002” and a right side shows the screen of a callee (receiver) having a temporary user ID “206-000-0005”. In an upper left portion of the caller's screen, the temporary user ID of the callee is displayed, and “Clash of Clans” is displayed in an upper portion of the screen as a ringtone is made at the callee, thus indicating which topic the user making the call is interested in.

More specifically, “206-000-0002 COC” is displayed on the display screen of the callee having the temporary user ID “206-000-0005”, so that the callee may first simultaneously check the purpose of a call and the caller, and communicate with the caller or make a connection later. In the field “From other caller” in a lower portion of the screen of each user system, when there is an additional user who requests communication such as a call or chatting during the current phone call, the user ID of the additional user is displayed. In the field “text”, chat text sent by the additional user is displayed. The field “AD” denotes a field provided to show a commercial banner advertisement or the like.

When a reception request signal is sent from the caller to the callee as shown in FIG. 3, the caller (206-000-0002)'s desired topic (“Clash of Clans”) is displayed on the display screen of the user system of the callee (206-000-0005), thus allowing the callee to previously determine which topic is related to the call made from the caller. A detailed embodiment for implementing such functionality will be described below. When a reception request signal is transferred to a callee client, and the callee client inquires the web server about the title of post data (hereinafter referred to as a ‘topic’ in the present invention) desired to be used by users together with information about the temporary user IDs of the caller and the callee, the web server transmits the title of the post data selected by the caller to the callee client via Hypertext Transfer Protocol (HTTP), and the title of the post data is displayed on the screen of the callee client.

Although the above description has been made based on a case where a call is connected, the topic may be transmitted immediately when a caller requests chatting or sending of text from the callee upon doing chatting or sending text.

Such a procedure may also be performed so that it is processed within the service provider system rather than via communication between the client (user system) and the web server according to the method of configuration. However, even in this case, there is no difference from the case where operation is performed between the client 110 or 120 and the web server, and thus it may be considered that the operations are conceptually identical to each other. Even if the user system is configured to operate in conjunction with a third server other than the service provider system, or even if the client is configured via communication between the phone 410 or 420 connected to the exchange system 300 and the web server or the service provider system, a conceptually identical service method is applied, and such a configuration should be understood to belong to the scope of the present patent.

An embodiment, in which an instance of a specific method for, when the caller clicks the topic enabling a connection to the callee, allowing the caller to be automatically connected to the callee without separately pressing the temporary user ID of the callee, is implemented in a JavaScript language will be described below. By entering the callee ID number (e.g., 206-000-0005) into the following “callee” field, a call is automatically connected.

function red5phone_getConfig( )
{
var callee = ″2060000005?
return {
callee: callee,
tapid: strTapId,
password: strPassWord
};
}

The program example is related to a flash phone. Even if the program is applied to an application (Android, iOS, etc.) or other programs, operations are not different from each other, and thus it may be considered that operations for respective Apps or programs are conceptually identical.

FIG. 4 is a flow diagram showing the flow of post management between user systems and a service provider system constituting the post management system according to an embodiment of the present invention. More specifically, FIG. 4 is a flow diagram illustrating the processing flow of a service in a case where, after a user system A 110 has input data and has been assigned a temporary user ID, a user system B 120 selects data of the user system A 110, receives a temporary user ID for the user system B 120, and performs communication. The user system A 110 accesses the service provider system 200 via a web browser or another communication interface method at step ST31. In this regard, the service provider system 200 transmits a webpage or data desired by the user to the user at step ST32. When the user system A inputs or selects post data, the corresponding information is input to the service provider system 200 at step ST33. A temporary user ID is assigned from the service provider system 200 to the user system A that input or selected the post data at step ST34. Before step ST34, the user system A 110 is in a state in which it does not yet input a user ID or any identification information enabling the user system A to be identified and discriminated from other user systems to the service provider system 200. That is, in a state in which a login procedure has not yet been performed, the user system A 110 may view posts provided by the service provider system 200, and input data including a topic. Thereafter, at step ST34, the temporary user ID enabling the user system A to be discriminated from other user systems is assigned from the service provider system 200. By means of a web browser or another communication interface method, the user accesses the service provider system 200 at step ST35. In this regard, the service provider system 200 transmits a webpage or post data desired by the user to the user at step ST36. As a communication method, when the user system B 120 of the user B takes interest in and selects a topic input or selected by the user system A 110 at step ST37, the service provider system 200 assigns a temporary user ID to the user system B 120 at step ST38. Similarly, before step ST38, the user system B 120 is in a state in which a user ID or any identification information enabling the user system B to be identified and discriminated from other user systems is not input to the service provider system 200. That is, in the state in which a login procedure is not performed, the user system B 120 may search the posts provided by the service provider system 200. After the topic input by the other user has been selected, a temporary user ID enabling the user system B to be discriminated from other user systems is assigned from the service provider system 200 at step ST38. The service provider system 200 requests communication from the user system A 110 at step ST39. As another method, the service provider system 200 requests communication from the user system having the post data based on the topic input or selected by the user system A 110 at step ST39. When the user system A accepts the communication request at step ST40, the service provider system 200 notifies the user system B 120 of the other party's communication acceptance at step ST41, and relays communication at step ST42.1 or directly processes communication at step ST42.2.

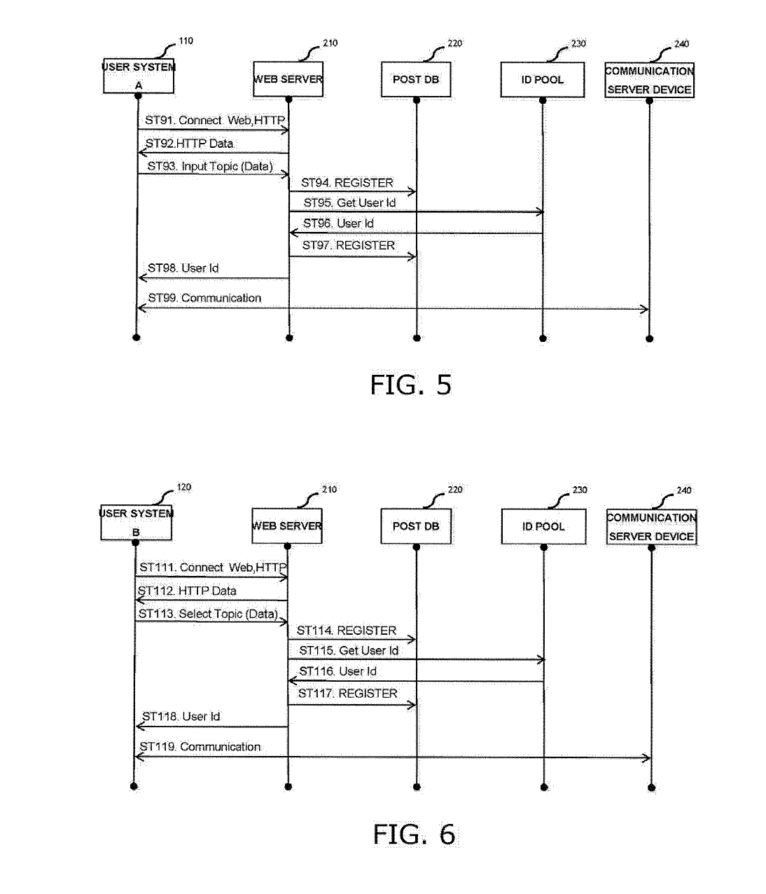

FIG. 5 is a flow diagram showing a procedure, in which after inputting post data, the user system A is assigned a temporary user ID from the service provider system, in the post management system according to the present invention. The user system A 110 accesses the web server 210 of the service provider system 200 via a web browser or another communication interface method at step ST91. In this regard, the web server 210 of the service provider system 200 transmits a webpage or post data desired by the user to the user at step ST92. When the user system A 110 inputs or selects post data, the corresponding information is transmitted to the web server 210 of the service provider system 200 at step ST93, and the received post data is registered in the DB 220 at step ST94. The web server 210 requests a temporary user ID to be used by the user system A from the ID pool 230 at step ST95. The ID pool 230 provides a temporary user ID to be used to the web server 210 in response to the request at step ST96. The web server 210 registers the post data received from the user system A and the temporary user ID in the DB 220 so that the post data matches the temporary user ID at step ST97, and then provides the temporary user ID to the user system A 110 at step ST98. Further, if necessary, the user system A communicates with another user system or other communication devices using the provided temporary user ID at step ST99. However, in the case of steps ST94 and ST97 corresponding to the procedure for registration by the web server 210 in the DB 220, only step ST94 or ST97 may be performed, or both steps may be performed. Further, the functionality of the ID pool 230 may be autonomously performed by the web server 210. According to the circumstances, the ID pool 230 may be located in a separate system other than the service provider system 200 and may be provided at the request of the service provider system 200. However, even in this case, such an operation is not different from that of a case where the IP Pool 230 is located in the service provider system 200 and is operated, and thus it may be considered that the operations are conceptually identical to each other. Even if the DB 220, the ID pool 230, or the communication server device 240 is configured using another system such as a cloud server, it should be understood that a conceptually identical service scheme is applied and such configuration is included in the scope of the patent.

When a communication session between the user system and the web server is terminated in such a way that the user system no longer uses the web service provided by the web server, the web server senses such the termination and withdraws the temporary user ID. That is, the web server returns the corresponding temporary user ID to the ID pool, thus allowing the temporary user ID to be assigned to another user system. Further, when the post data input by the corresponding temporary user system is stored in the DB, the web server instructs the post data to be deleted.

FIG. 6 is a flow diagram showing a procedure, in which user system B selects a topic created by another user and is then assigned a temporary user ID from the service provider system, in the post management system according to the present invention. In FIG. 6, all steps except step ST113 of FIG. 6 are identical to the corresponding steps of FIG. 5, and thus only step ST113 will be described below. When the user system B 120 selects a topic posted by another user system, the corresponding topic information is transmitted to the web server 210 of the service provider system 200 at step ST113, and the received post data is registered in the DB 220 at step ST114.

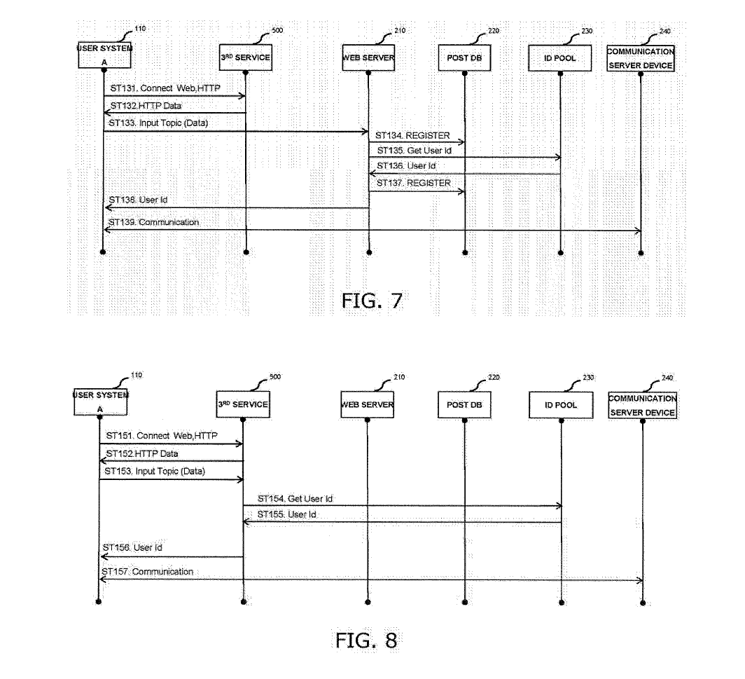

FIG. 7 is a flow diagram showing a procedure, in which user system A and the service provider system are connected together to a third service and perform a service, in the post management system according to the present invention. The term “third service” denotes a service connected via an additional website and is performed such that the user system A 110 accesses a third service 500 via a web browser or another communication interface method at step ST131. In this regard, the third service 500 transmits a webpage or post data desired by the user to the user at step ST132. Thereafter, subsequent steps ST133 to ST139 are identical to the corresponding steps ST93 to ST99 presented in FIG. 5, and thus a detailed description thereof will be omitted.

FIG. 8 is a flow diagram showing a procedure, in which user system A and the service provider system are connected together to a third service to perform a service and the third service is performed on behalf of an operation executed by a conventional service provider system, in the post management system according to the present invention. The user system A 110 accesses a third service 500 via a web browser or another communication interface method at step ST151. In this regard, the third service 500 transmits a webpage or post data desired by the user to the user at step ST152. When the user system A 110 selects a topic, the corresponding topic information is transmitted to the third service 500 at step ST153. The third service 500 requests a temporary user ID to be used by the user system A corresponding to the received topic from the ID pool 230 at step ST154. The web server 210 provides the temporary user ID assigned from the ID pool 230 or the third service 500 to the user system 110 so that the topic received from the user system A 110 matches the temporary user ID at step ST156. In addition, if necessary, the user system 110 communicates with another user system or other communication devices using the provided temporary user ID at step ST157. The third service 500 may register post data or the like in its own DB or the DB 220 of the service provider system 200 or an external additional DB. Furthermore, the functionality of the ID pool 230 may be autonomously performed by the third service 500. In contrast, the ID pool 230 may be provided at the request of the web server 210 which received the request of the third service 500.

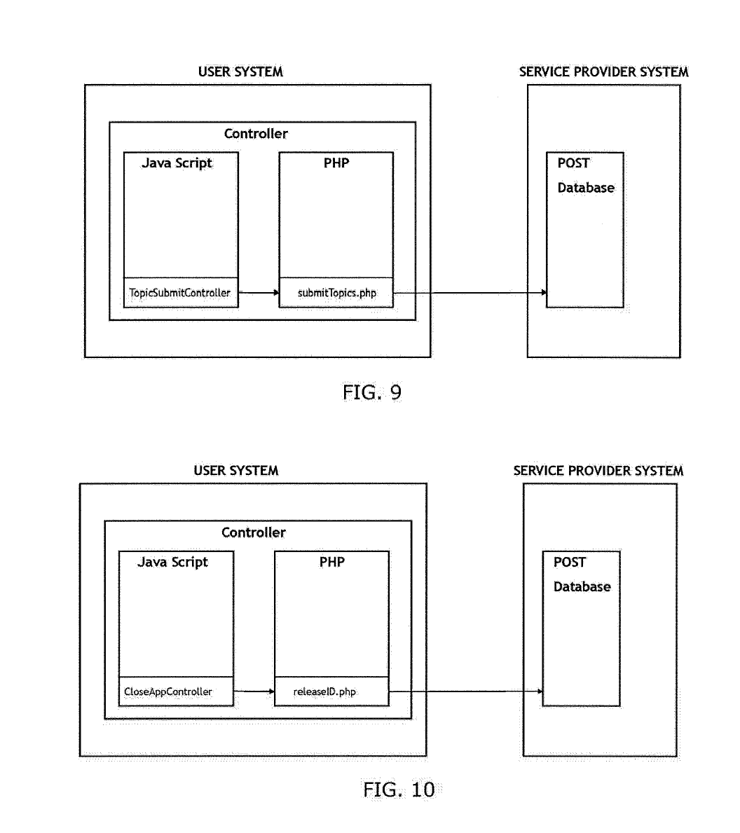

FIG. 9 is a diagram showing an embodiment of a program language by which, when user system A inputs post data, a temporary user ID is assigned to the user system A from the service provider system, in the post management system according to the present invention. Expressions such as TopicSubmitController, submitTopics.php, CloseAppController, and releaseID.php used in FIGS. 9 and 10 are terms used in specific development for a specific service and may be changed as random names by a developer. However, even if random names are used, the changed names may also be included in the scope of the accompanying claims of the present invention as long as the same or similar operation is performed.

More specifically, the drawing illustrates a procedure in which the user system A inputs a desired topic according to the input format provided by the service provider system and topic data created by the user's input is stored in the DB of the service provider system.

Example of Program Coding for Describing Processing Procedure Upon Inputting Topic

```
topicApp controller (′TopicSubmitController′, function ($scope,$http)
{ $scope.submitForm = function( ) { console.log(″data sending....″);
  $http.post(′submitTopics.php′, JSON.stringify($scope.myTopics)).success(function( ){console.log(″data sent″);
  angular.element(″.message″).html(″<span>Thanks! Your topics have been created below.</span>″); }); }; });
.
$json = file_get_contents(′php://input′);
$obj = json_decode($json);
.
$topic1 = $obj->{topic1};
$topic2 = $obj->{topic2};
$topic3 = $obj->{topic3};
.
if($topic1){$DB->Query(″INSERT INTO topics(topic) VALUES(′$topic1′)″);}
if($topic2){$DB->Query(″INSERT INTO topics(topic) VALUES(′$topic2′)″);}
if($topic3){$DB->Query(″INSERT INTO topics(topic) VALUES(′$topic3′)″);}
```

The controller of the user system is composed of JavaScript and Hypertext preprocessor (PHP), wherein JavaScript includes TopicSubmitController, and PHP includes submitTopics.php. A topic entered by the user is input to the JavaScript and is transmitted to the PHP, so that the topic is transmitted to and recorded in the post DB of the service provider system. A detailed description will be made below.

In the stage of the program code,

```
  topicApp.controller (′TopicSubmitController′, function ($scope,$http)
  { $scope.submitForm = function( ) {console.log(″data sending...″);
  $http.post(′submitTopics.php′,JSON.stringify($scope.myTopics)).success(function( ){
console.log(″data sent″);
  angular.element(″.message″).html(″<span>Thanks! Your topics have been created
below.</span>″); }); }; });
```

console.log(“data sending . . . ”) explains that the TopicSubmitController of JavaScript of the controller sends the topic entered by the user to the PHP, and console.log(“data sent”); explains that the topic has reached the PHP.

In the stage of $json=file_get_contents(‘php://input’); the topic is recorded in the submitTopics.php of the controller in the PHP of the controller. Further, in the stage of $obj=json_decode($json); the topic is decoded into the PHP from the JavaScript in submitTopics.php.

Further, in a subsequent stage,

$topic1=$obj->{topic1};

$topic2=$obj->{topic2};

$topic3=$obj->{topic3};

explain that, when there are three topics, that is, A, B, and C, as the topics entered by the user via the user system, the respective topics are defined by the formats of $topic1=$obj->{topic1};$topic2=$obj->{topic2}; $topic3=$obj->{topic3}.

Further, a subsequent stage:

if($topic1){$DB->Query(“INSERT INTO topics(topic) VALUES(‘$topic1’)”);}

if($topic2){$DB->Query(“INSERT INTO topics(topic) VALUES(‘$topic2’)”);}

if($topic3){$DB->Query(“INSERT INTO topics(topic) VALUES(‘$topic3’)”);}

explain that, when a topic is present, the user system transmits the topic to the DB of the service provider system. For example, when there is Topic1, Topic1 is recorded in the DB table topics(topic) VALUES(‘$topic1’) named “topics” in the post DB present in the service provider system. This procedure is performed in the same manner if there are Topic2 and Topic3.

FIG. 10 illustrates an embodiment of a program language describing a procedure, in which an assigned temporary user ID is withdrawn when a user system assigned the temporary user ID terminates a web or an application in use and terminates a session, in the post management system according to the present invention.

Example of Program Coding Describing Temporary User ID Termination Procedure

topicApp controller (′CloseAppController′, function ($scope,$http) {$scope.closeApp = function ( ) {
console.log(″sending ID....″); $http.post(′releaseID.php′, JSON.stringify($scope.myID)).success(function( )
{console.log(″sent ID″);angular.element(″.message″).html(″<span>Thanks for using TopicB!.</span>″); }); }; });
.
$json = file_get_contents(′php://input′);
$obj = json_decode($json);
$id = $obj->{myID};
.
$DB->Query(″UPDATE * topics(topic) WHERE ID=′$id′)″);

The controller of the user system is composed of JavaScript and PHP, wherein JavaScript includes CloseAppContoller, and PHP includes releaseID.php. When the use of a service is terminated by the user system, such a program is executed at JavaScript and the temporary user ID is sent to the PHP and is then sent to the service provider system. In a detailed description,

```
  topicApp.controller(′CloseAppController′, function ($scope,$http) {$scope.closeApp =
function( ) {
  console.log(″sending ID...″); $http.post(′releaseID.php′,
JSON.stringify($scope.myID)).success(function( )
  {console.log(″sent ID″);angular.element(″.message″).html(″<span>Thanks for using
TopicB!.</span>″); }); }; });
```

console.log(“sending ID . . . ”) explains that the CloseAppController of JavaScript of the controller sends an ID (temporary user ID) to the PHP, and that console.log(“sent ID”) reaches the PHP.

Further, in a subsequent stage, that is, $json=file_get_contents(‘php://input’); an ID (temporary user ID) is recorded in the releaseID.php of the controller in the PHP of the controller. Furthermore, in the stage of $obj=json_decode($json); the data is decoded from the JavaScript into PHP in the releaseID.php.

Furthermore, in a subsequent stage $id=$obj->{myID}; an ID (temporary user ID) is defined.

Furthermore, a subsequent stage, that is,

$DB->Query(“UPDATE topics(topic) WHERE ID=‘$id’)”); explains that, when a session with the user system is terminated, information indicating that the corresponding ID is not used is sent from the user system to the service provider system.

In FIG. 10, an example in which when a session between the user system and the service provider system is terminated, only the temporary user ID is withdrawn has been described. However, when there is post data received from the corresponding user system, the system is implemented such that the corresponding post data is deleted together with the temporary user ID from the post DB.

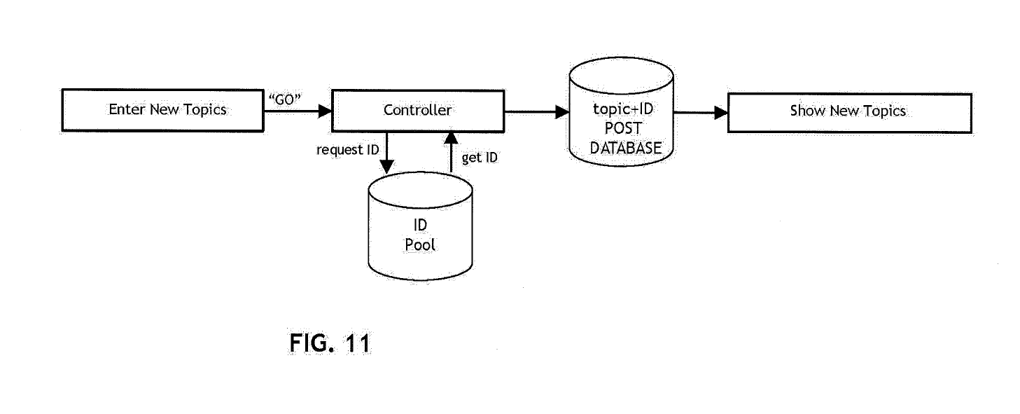

FIG. 11 is a flow diagram showing a method in which the post management system stores post data according to the present invention. As shown in FIGS. 9 and 10, when the user system inputs post data (topic), the web server controller of the service provider system requests a temporary user ID corresponding to the post data (topic) from the ID pool and is assigned the temporary user ID from the ID pool. The assigned temporary user ID and topic (topic+ID) are transmitted to and stored in the post DB of the service provider system. That is, in a conventional post management system, when a user assigned a user ID enters post data, the corresponding post data is stored together with the user ID. However, the post management system of the present invention, when a user (user system) assigned no user ID enters post data (topic), the service provider system assigns a temporary user ID and then stores the post data together with the temporary user ID assigned by the service provider system in a topic+ID DB.

Unlike a conventional scheme in which, as the post data created by the user system is combined with the corresponding user ID based on a preset user ID, and a combination thereof is stored in the post DB of the service provider system, the present invention combines an ID (temporary user ID), subsequently assigned by the service provider system in a time-series manner, with post data (topic) input by the user system in a state in which a preset user ID is not assigned, and stores the combined results in the post DB. That is, from the standpoint of time-series, unlike conventional technology that exploits a scheme for storing topics and contents based on a predefined user ID, the present invention exploits a scheme for first receiving post data (topic), subsequently assigning an ID (temporary user ID) newly generated based on the corresponding post data, and thereafter storing the assigned ID and the post data. Due to such a difference, when the present invention is applied, the temporary user ID is generated based on the post data, so that communication services may be performed regardless of the type of electronic devices or the situation of the user, thus enabling CaaS based on unique post data to be provided. Compared to this, the conventional scheme is limited in that it requires a predefined user ID and must perform communication only based on the corresponding user ID.

Of course, the flow presented in FIG. 11 may be modified in various manners. For example, an embodiment has been described in which when a topic is input from the user system, a temporary user ID is first assigned and “topic+ID” is then stored in the post DB. However, such an embodiment may be modified and performed via a procedure in which, when a topic is input from the user system, the corresponding topic is stored in the post DB, and then a temporary user ID is assigned and stored in the post DB.

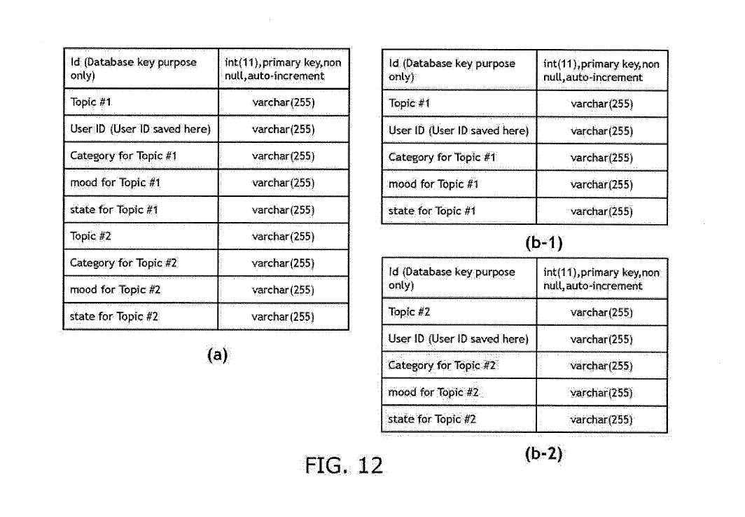

FIG. 12 is a diagram showing an example of the configuration of the post DB according to an embodiment of the present invention. Two schemes for implementing the post DB when the user enters two topics (topic #1 and topic #2) will be described below.

A first scheme is to assign a single post ID and manage the post using the corresponding post ID as a primary key, as presented in a first field shown in (a) of FIG. 12. For the post ID, pieces of information about topic #1 and topic #2 are simultaneously stored. A second field (Topic #1) is a field related to the topic corresponding to Topic #1, a third field is a field related to a temporary user ID, and fourth, fifth and sixth fields are fields respectively related to the category, mood, and state of Topic #1. Seventh to tenth fields are fields respectively related to the topic, category and state of Topic #2.

A second scheme is to assign post IDs to respective topics and manage posts by using the post IDs as primary keys, as shown in (b-1) and (b-2) of FIG. 12. FIG. 12 (b-1) illustrates a state in which fields for a post ID for Topic #1, a topic, a temporary user ID assigned from the service provider system, and the category, mood, and state of Topic #1 are stored. FIG. 12 (b-2) illustrates a state in which fields for a post ID for Topic #2, a topic, a temporary user ID assigned from the service provider system, and the category, mood and state of Topic #2 are stored. When a user who entered Topic #1 and a user who entered Topic #2 are identical, the temporary user IDs stored in (b-1) and (b-2) of FIG. 12 are identical to each other. Alternatively, it is possible to assign different temporary user IDs for respective topics.

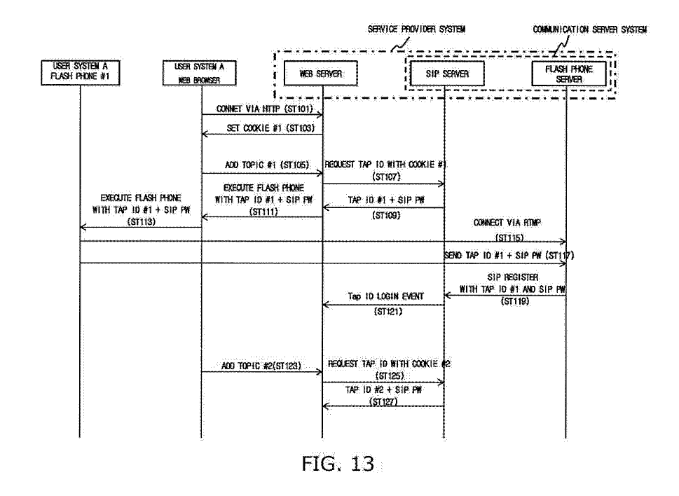

FIG. 13 is a flow diagram showing a procedure in which the post management system according to the present invention processes a phone call. It is assumed that user system A is provided with flash phone #1 operating in a flash manner, and that signaling of a voice call or a video call between a user agent and a callee-side phone is conducted based on a Session Initiation Protocol (SIP). Further, in the configuration diagram presented in FIG. 13, a description is made on the assumption that an SIP server also performs the function of the ID pool of FIG. 1 together with its own function. The SIP server, which is a server device for processing the SIP protocol, takes charge of call processing in the SIP protocol. Therefore, the SIP server may be regarded as a call processing server for phone calls. The flash phone server is a server for processing a phone call between flash phones, and may be universally regarded as a phone call processing server.

When user system A attempts to make an HTTP connection at step ST101, the web server provides cookie #1 at step ST103. The cookie #1 provided at step ST103 is used to identify each browser when a plurality of web browsers are executed on the user system A. However, this step is not necessarily performed so as to practice the present invention. When the user system A inputs topic #1 at step ST105, the web server of the service provider system recognizes the topic #1, and requests a temporary user ID (Tap id) for a phone call from the SIP server while providing the cookie #1 to the SIP server at step ST107. In response to the request, the SIP server provides a temporary user ID for a phone call together with a phone call password (sip pw) at step ST109. Since the password provided at step ST109 is a password necessary for security in order to prevent the occurrence of future phone-tapping or the like, it is not necessarily required to practice the present invention. The web server requires the execution of the flash phone while providing the temporary user ID for a phone call and the password to the web browser of user system A at step ST111. The user system A creates and executes the flash phone at step ST113. Thereafter, for telephone communication, the flash phone #1 of the user system A is connected to a flash phone server via a Real Time Message Protocol (RTMP) at step ST115, and authenticates whether a phone call has been correctly made via the SIP server at step ST119 while sending the temporary user ID for a phone call and the password at step ST117. Thereafter, the flash phone #1 instructs the web server to use the phone at step ST121.

When the user system A inputs topic #2 using another web browser at step ST123, the web server of the service provider system recognizes the input of the topic #2, and requests a temporary user ID (Tap id) for a phone call from the SIP server while providing new cookie #2 to the SIP server at step ST125. The SIP server provides the temporary user ID for a phone call together with a password (sip pw) in response to the corresponding request at step ST127.

In FIG. 13, when the ID pool 230 (see FIG. 1) is provided separately from the SIP server, it should be understood that steps ST107, ST109, ST125, and ST127 that are performed between the web server and the SIP server will be conducted between the web server and the ID pool. Further, in FIG. 13, although a procedure for performing telephone communication between users has been described, a procedure for doing chatting is performed in almost similar manner. In this case, a chatting server device must be included in the communication server device.

The present invention uses a procedure for assigning a temporary user ID based on post data (topic) entered or designated by the user. When the temporary user ID assigned at this time is an internationally used phone number, phone users anywhere in the world may freely make or receive a call.

It is apparent that, in relation with temporarily user IDs provided by the service provider system 200 shown in FIGS. 1 to 8, additional modifications are possible. For example, in the present invention, the service provider system 200 assigns temporary user IDs in a CaaS manner, but a scheme for allowing a third service provider system connected to the service provider system 200 to assign temporary user IDs may be applied. This case may be implemented such that affiliated services with other companies enabling service collaboration or business collaboration with the service provider system 200 are conducted.

As another embodiment, when the user directly enters an ID, the user recognizes that his or her ID entered thereby is used. However, actually, the service provider system may assign a temporary user ID in another CaaS manner, and match the temporary user ID with the user ID personally entered by the user. Therefore, upon connecting service or communication in the service provider system, if signal processing is performed based on CaaS, the ID directly entered by the user is only a simple additional procedure from the standpoint of the internal configuration of the system and the service, and there is no difference upon performing service and communication even if the corresponding procedure is not used. It should be understood that even such a case is included in the scope of the present invention.

A conventional post management scheme enables posts to be managed after a user logs in to the corresponding website, and thus it is difficult for such a conventional structure to provide communication without opening an amount of information related to subscriber information or the like to the corresponding post management system.

In contrast, the present invention provides characteristics that only in case of need, such as in a case where a user desires to register posts or to comments on posts registered by others, or to communicate with a user who registered a corresponding post, a temporary user ID is assigned while the user is not aware of the assignment of the ID. In accordance with the present invention, the user may directly communicate with a posting user by means of posts without entering personal information such as a user ID or a phone number.

The present invention provides a temporary user ID based on post data instead of providing a temporary user ID based on a user, thus providing an open communication type suitable for an Internet environment, a big data environment, and a cloud environment.

Although specific embodiments of the present invention have been described and illustrated, it is apparent that the present invention may be modified and practiced by those skilled in the art of the present invention without departing from the scope and spirit of the invention. Such modifications should not be separately understood from the spirit and scope of the present invention, and may be regarded as being included in the accompanying claims of the present invention. It is apparent that the present invention may be easily applied to text, images, voice, video calls, chatting, and advertising.

What is claimed is:

1. A method for managing posts, the method being performed by a post service provider system connected between user system A and user system B via data communication and configured to provide a plurality of posts so that the posts are registered or viewed, and to provide data communication connection between the user system A and the user system B, comprising:
a) inputting post data from the user system A in a state in which a user Identification (ID) enabling the user system A to be discriminated from other user systems is not provided;
b) assigning a temporary user ID enabling the user system A to be discriminated from other user systems;
c) registering the post data input by the user system A at a), together with the temporary user ID assigned at b), in a database (DB); and
c) when a communication session between the user system A and the post service provider system is terminated, withdrawing the temporary user ID assigned to the user system A and deleting the post data and the temporary user ID registered in the DB at c).

2. The method of claim 1, wherein the temporary user ID is an identifier that is identifiable by an exchange device for connecting telephone communication between typical phones.

3. A method for storing posts in a post database (DB), the method being performed by a post service provider system connected between user system A and user system B via data communication and configured to provide a plurality of posts so that the posts are registered or viewed, and to provide data communication connection between the user system A and the user system B, comprising:
a) inputting post data from the user system A in a state in which a user Identification (ID) enabling the user system A to be discriminated from other user systems is not provided;
b) assigning a temporary user ID enabling the user system A to be discriminated from other user systems to the post data based on the post data;
c) storing the post data and the temporary user ID in the post DB.

4. The method of claim 3, wherein the temporary user ID is an identifier that is identifiable by an exchange device for connecting telephone communication between typical phones.

5. A post service provider system, the post service provider system being connected between user system A and user system B via data communication and being configured to provide a plurality of posts so that the posts are registered or viewed, and to provide data communication connection between the user system A and the user system B, comprising:
a web server for providing a web service both to the user system A and to the user system B, inputting post data from the user system A in a state in which a user ID enabling the user system A to be discriminated from other user systems is not provided from the user system A, and requesting identification information enabling the user system A to be discriminated from other user systems;
an ID pool for receiving a request for the identification information from the web server, and providing a temporary user ID enabling the user system A to be discriminated from other user systems when the post data is input;
a database (DB) for storing the temporary user ID and the post data; and
a communication server device for connecting data communication between the user system A and the user system B.

6. The post service provider system of claim 5, wherein the temporary user ID is an identifier that is identifiable by an exchange device for connecting telephone communication between typical phones.
